(19) United States
(12) Patent Application Publication
(10) Pub. No.: US 2018/0309977 A1
(43) Pub. Date: Oct. 25, 2018

(54) OPTICAL SPLITTER, 3D IMAGE PROCESSING SYSTEM AND 3D IMAGE VISUALIZATION SYSTEM

(71) Applicant: REALVISION S.R.L., Sesto Calende Varese (IT)

(72) Inventors: Sabino PISANI, Rescaldina Milano (IT); Daniele DE MOLLI, Sesto Calende Varese (IT)

(73) Assignee: REALVISION S.R.L., Sesto Calende Varese (IT)

(21) Appl. No.: 15/738,009

(22) PCT Filed: Jun. 15, 2016
(86) PCT No.: PCT/IB2016/000895

§ 371 Date: Dec. 19, 2017

(30) Foreign Application Priority Data
Jun. 19, 2015 (IT) 102015000025646

(51) Int. Cl. H04N 13/239; G02B 27/10; H04N 5/225; G02B 27/09

(52) U.S. Cl. CPC H04N 13/239; G02B 27/0955; H04N 5/2254; G02B 27/106

(57) ABSTRACT

The present invention is directed to an optical splitter (1), connectable to a tool (2) for the detection of sequences of two-dimensional images (IM1i;IM2i) along their respective directions of shooting, including elaboration optics (Ot1;Ot2) configured to receive two-dimensional image sequences (IM1i;IM2i), to elaborate them by determining processed image sequences (IM1iE;IM2iE) and transmit the processed image sequences (IM1iE;IM2iE) along their respective transmittal directions (d3;d4); the optical splitter also comprises data link communication between cameras (TC1;TC2) and their respective elaboration optics (Ot1;Ot2) where cameras (TC1;TC2) are configured to receive processed two-dimensional image sequences (IM1iE;IM2iE) along their respective transmittal directions (d3; d4) and where the cameras (TC1; TC2) are oriented in parallel position among 103 their respective transmittal directions (d3; d4). The invention also describes a 3D image processing system (11) including the detection tool (2), said optical splitter (1) and a corresponding control unit (UC). The invention further describes a 3D display system (111) comprising said 3D image processing system (11) and a display device (D3D) configured to receive and view viewable images (I_3D) produced by 3D image processing system.

The present invention is directed to an optical splitter, i.e. a system to transform an image viewable trough a binocular system to a digital image for a display.

In particular, in one embodiment, the present invention system is directed to an optical splitter including two cameras, a system of prisms and a system for the digital image elaboration, and the following description refers to this technical field without limiting the scope of protection.

The system according to the invention can be used instead of the binocular system or in addition to this, allowing the operator of viewing both via binocular system and on a display.

In a preferred embodiment of the invention, the display of the device is a 3D display without glasses.

A particularly useful binocular system of the present invention is the microscope. In particular, the present invention allows to transform a traditional optical microscope into a digital one, optionally 3D, situation that at the moment would require microscope replacement.

Thus, scope of the present invention is to supply a system able to adapt to each type of binocular viewer, and able to convert the binocular viewer image into a digital image, for example to convert an optical microscope in a digital microscope.

The present invention has as a further scope a 3D image elaboration system including said optical splitter.

The present invention has as a further object a 3D image visualization system including the above mentioned processing system.

In the last few years, digital microscopes have been developed. i.e. they supply a digital version of the image obtained by the microscope. Said microscopes can be either equipped by a 3D viewer or connected to an external monitor.

Digital microscopes differ from the traditional optical ones for the presence of two cameras converting the image in a digital signal.

In a first aspect, the optical splitter is linkable to a detection tool of two-dimensional image sequences along their respective directions of shooting, such as a microscope.

The optical splitter comprises elaboration optics configured to receive two-dimensional image sequences, processing them by determining processed image sequences; transmit processed images along their respective transmittal directions.

The optical splitter comprises cameras coupled to respective camera lens and in data link communication between respective elaboration optics wherein cameras are configured to receive two-dimensional image sequences processed through the camera lenses along their respective transmittal direction; wherein the cameras are oriented in parallel position among their respective transmittal directions.

Preferably, elaboration optics comprise one enlarging lens configured to resize input two-dimensional images, determining enlarged processed two-dimensional images.

Preferably, the elaboration optics comprise a manual focus.

Preferably, elaboration optics comprise respective prisms equipped with a couple of respective lens, one positive and one negative, configured to resize input two-dimensional images, determining resized processed two-dimensional images.

Preferably, the optical splitter comprises deflection means, interposed between elaboration optics and related cameras, equipped with two adjusting prisms configured to adapt the system, having fixed axial distance between the cameras, to binocular systems having axial distance between the two eyes different with respect to the distance between cameras.

Preferably, in a first embodiment, the distance between directions of shooting correspond respectively to transmittal directions being unchanged a first distance existing during the shooting of the two-dimensional image sequences and the transmission of processed two-dimensional images, wherein with the expression “distance between transmittal directions” it is intended the distance between axes of cameras having parallel axes between them.

Preferably, in a second embodiment, shooting directions are at a higher distance compared to the distance between axes of the cameras.

Preferably, in a third embodiment, shooting directions are at a shorter shooting distance compared to the distance between axes of the cameras.

In the second aspect, the 3D image processing system comprises: a tool for the detection of two-dimensional image sequences along the respective shooting directions, an optical splitter, as described in the first aspect of the invention, configured to receive two-dimensional image sequences; a control unit including: a receiving modulus configured to receive processed images from the optical splitter; a synchronization modulus configured to synchronize processed images, thereby generating viewable images.

Preferably, the synchronization modulus is configured to synchronize images by making a juxtaposition of images coming from cameras and a consequent interlacing, thereby realizing viewable images.

In the third aspect, the 3D image viewer system comprises: a 3D image processing system as described in the second aspect of the invention; a visualization device configured to receive and display viewable images.

Preferably, the visualization device is configured to receive images viewable through cabled network or wireless network.

Preferably the visualization device comprises a transparent support which realizes one between a mobile phone display, tablet or similar or one between PC monitors, TV or similar.

Technical effects of the invention will be shown more in details in the following description of a realization example, which is merely indicative and not limitative, with reference to the enclosed drawings.

### BRIEF DESCRIPTION OF THE DRAWINGS

FIG. 1 is a block diagram of a visualization system according to the prior art.

FIG. 2A shows an optical splitter scheme, a 3D image elaboration system, and a 3D image visualization system according to a first preferred embodiment of the invention.

FIG. 2B shows a scheme of an optical splitter, a 3D image processing system and a 3D images visualization system according to a second preferred embodiment of the invention.

FIG. 2C shows a scheme of an optical splitter, a 3D image processing system and a 3D image visualization system according to a third preferred embodiment of the invention.

FIG. 3A shows a first variant of a component of the optical splitter of FIGS. 2A, 2B and 2C (single lens).

FIG. 3B shows a second variant of one component of the optical splitter of FIGS. 2A, 2B and 2C (prismatic lens).

FIGS. 4A, 4B show a 3D visualization device of the 3D image visualization system in a first embodiment of the invention.

FIGS. 5A, 5B show a 3D visualization device of the 3D image visualization system in a second embodiment of the invention.

FIG. 6A shows a component of the optical splitter of FIG. 2B.

FIG. 6B shows a component of the optical splitter of FIG. 2C.

FIG. 7 shows an example of optical splitter according to the invention.

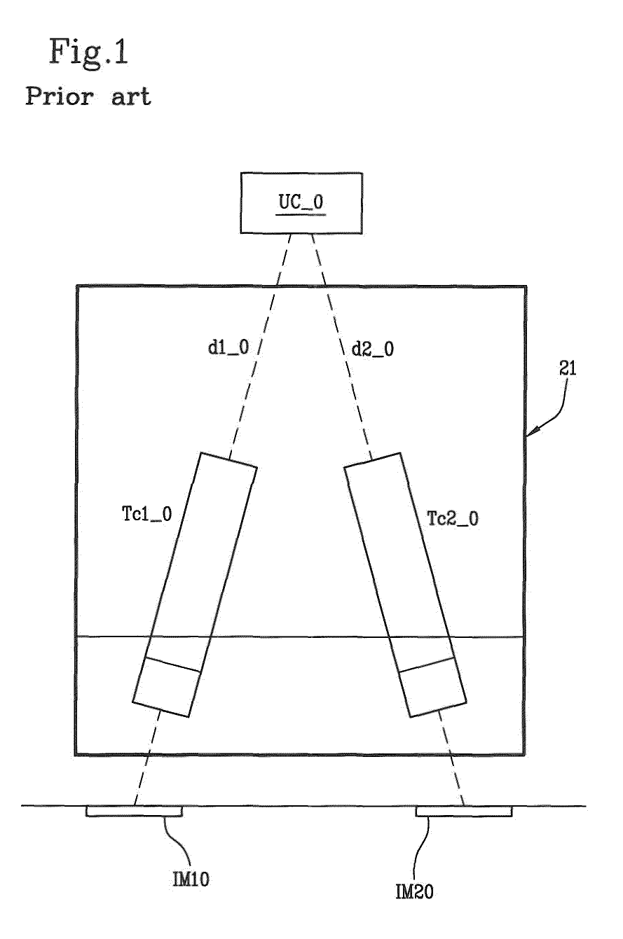

### DETAILED DESCRIPTION

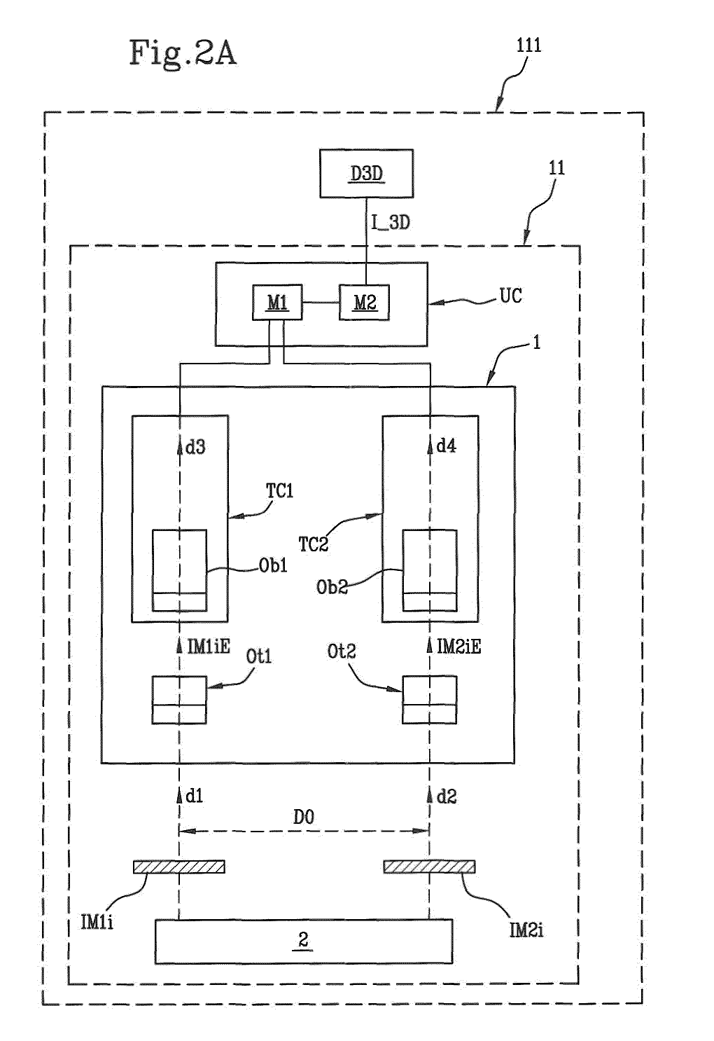

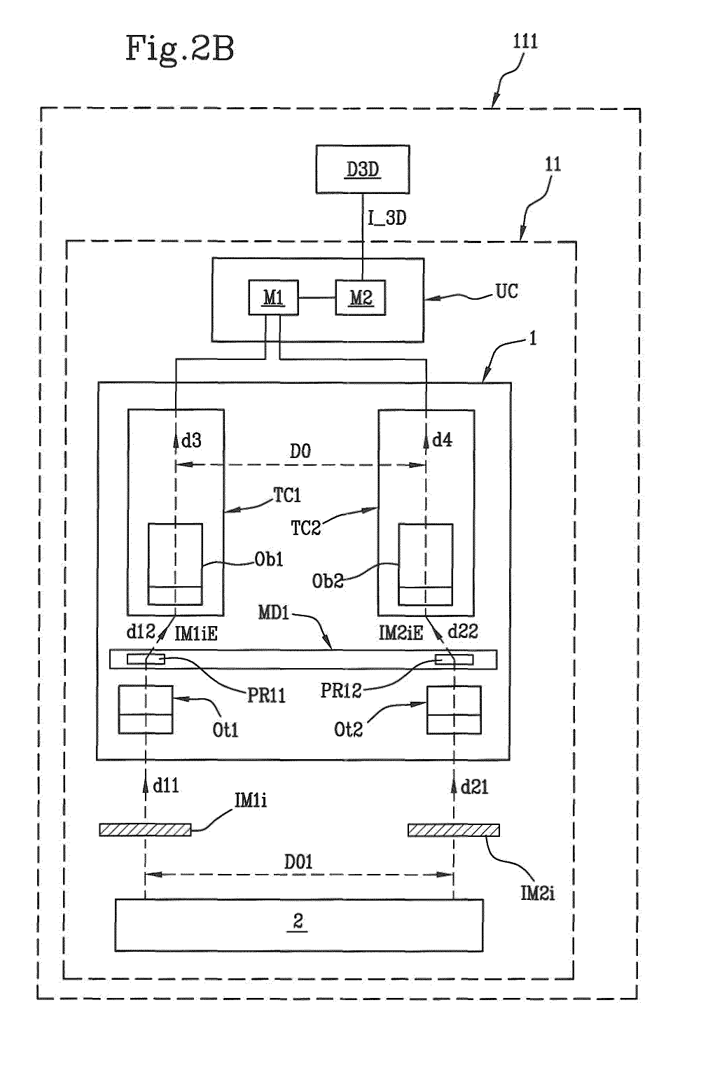

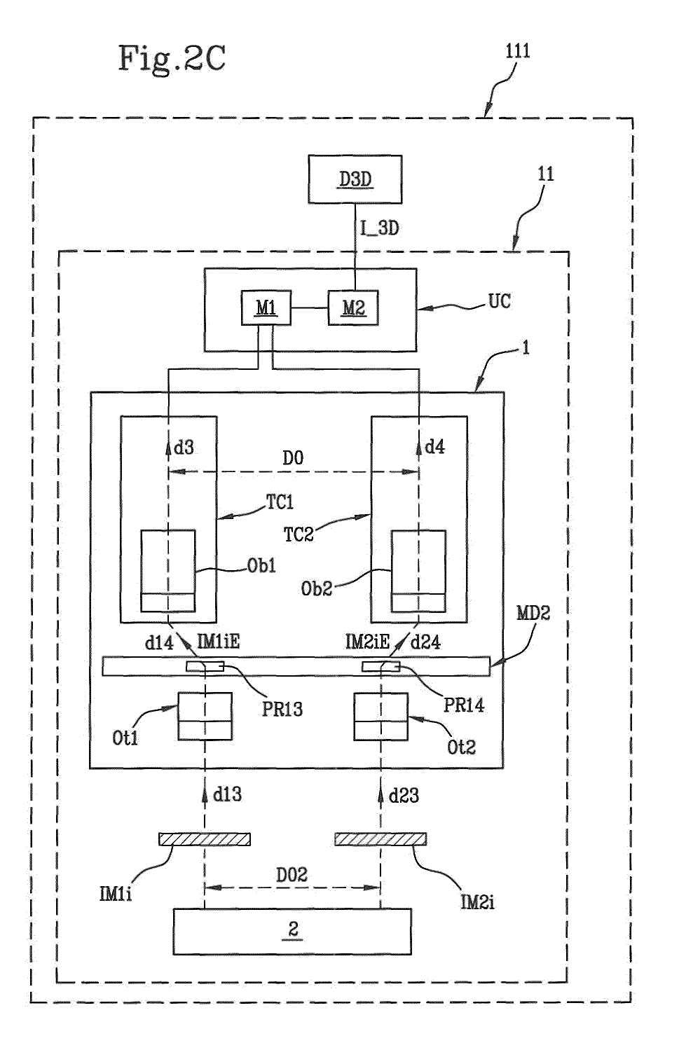

With particular reference to FIGS. 2A, 2B and 2C, an optical splitter (1), according to a preferred embodiment of the invention, comprises elaboration optics (Ot1, Ot2) and cameras (TC1, TC2) via data link communication with their respective elaboration optics (Ot1, Ot2). Elaboration optics (Ot1, Ot2) are preferably optical deviation prisms and arc used in the event of maintaining both the binocular viewer and the digital display.

Particularly, cameras (TC1, TC2) are allocated and fixed inside the optical splitter (1).

The optical splitter can also be indicated ad optical divider, or distribution frame.

The optical splitter is configured for acquiring and processing images broadcasted through the cameras.

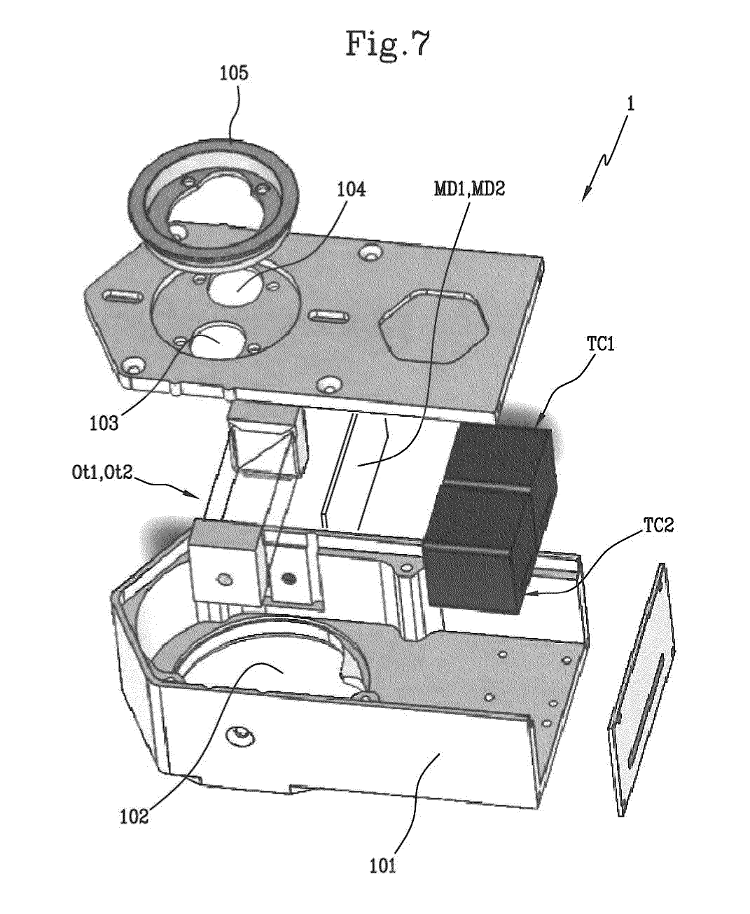

An optical splitter according to the invention, exploded in its components, is also shown in FIG. 7; particularly, in said figure it is shown the real construction of the splitter, suitable to use, in which, for reasons of simplification, lenses Ob1 and Ob2 are not shown.

The optical splitter (1) is connectable to a tool (2) for the detection of two-dimensional image sequences IM1i; IM2i.

The detection tool (2) shoots image sequences along their respective shooting directions (d1, d2, d11, d21, d13, d23). With image sequences it is intended photographs, images and footages even in very high resolution. In an embodiment of the invention, the detection tool (2) is an optical tool, for example an optical microscope.

In a first embodiment, shown in FIG. 2A, two-dimensional image sequences (IM1i; IM2i) are shoot along shooting directions (d1, d2). Shooting directions (d1, d2) are spaced of a measure equal to a shooting distance (D0).

In a second embodiment, shown in FIG. 2B, two-dimensional image sequences IM1i, IM2i are shoot along shooting directions (d11, d12). Shooting directions (d11, d21) are spaced of a measure equal to a shooting distance (D01), greater than the shooting distance (D0).

In a third embodiment, shown in FIG. 2C, two-dimensional image sequences (IM1i; IM2i) are shoot along shooting directions d13, d23. Shooting directions (d13, d23) are spaced of a measure equal to a shooting distance (D02), smaller than the first shooting distance (D0).

Elaboration optics (Ot1, Ot2) are configured to receive the two-dimensional image sequences (IM1i, IM2i). Elaboration optics (Ot1, Ot2) arc also configured to elaborate two-dimensional images sequences (IM1i; IM2i) determining processed digital image sequences (IM1iE; IM2iE).

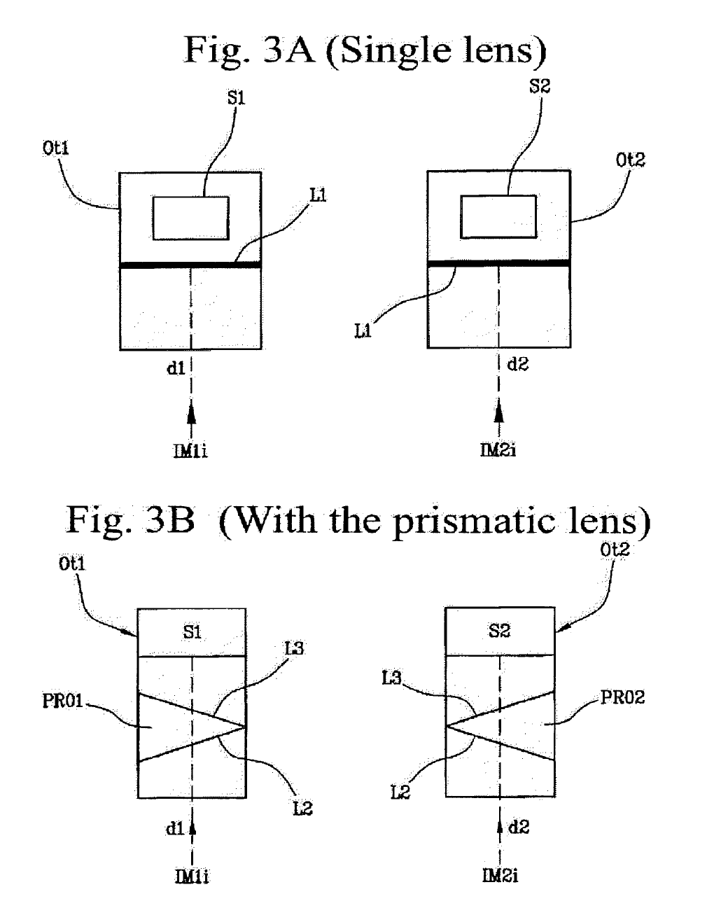

In one embodiment, shown in FIG. 3A, elaboration optics (Ot1, Ot2) comprise an enlarging lens L1 configured to resize entering two-dimensional images (IM1i, IM2i). The achieved technical effect is the determination of enlarged processed two-dimensional images (IM1iE; IM2iE).

In one embodiment, shown in FIG. 3B, elaboration optics (Ot1, Ot2) comprise respective prisms (PR01, PR02) equipped with a couple of respective lenses (L2, L3), configured to resize entering two-dimensional images, determining reduced processed two-dimensional images (IM1iE, IM2iE).

Usefully, the couple of lenses (L2, L3) comprises one positive lens and one negative lens; that is, the couple of lenses (L2, L3) comprises one divergent lens (L2) i.e. able to reduce the convergence of incident rays and one convergent lens (L3), i.e. able to increase the convergence of incident rays. The achieved technical effect is a determination of two-dimensional resized processed images (IM1iE; IM2iE).

Preferably, in both variants, elaboration optics (Ot1, Ot2) comprise a manual focus. Elaboration optics (Ot1, Ot2) are also configured to transmit processed image sequences (IM1iE; IM2iE) along their respective transmittal direction (d3, d4), as shown in FIGS. 2A, 2B and 2C. As already mentioned, transmittal directions (d3, d4) correspond to the axes of cameras.

In one embodiment, shown in FIG. 2A, first shooting directions (d1, d2) correspond respectively to transmittal directions (d3, d4). In other words, the first shooting distance (D0), present on two-dimensional image sequences shooting (IM1i, IM2i) is equal to the distance between transmittal directions of the processed two-dimensional images (IM1iE; IM2iE) and to the distance between axes of cameras (d3, d4).

In other words, in a preferred embodiment, as shown in FIG. 2, shooting direction (d1) is coincident with transmittal direction (d3), while the shooting direction (d2) is coincident with the transmittal direction (d4).

In one embodiment, shown in FIG. 2B, shooting directions (d11, d21) are at a shooting distance (D01) of two-dimensional image sequences (IM1i, IM2i) where said distance (D01) is higher than the shooting distance (D0) coincident with the distance between d3 and d4 of the processed two-dimensional images (IM1iE, IM2iE).

In other words, as shown in FIG. 2B, the shooting distance of the detection tool (2) must be adapted, in this case reduced, to be compatible with the distance between axes of the cameras. In one embodiment, as shown in FIG. 2C, third shooting directions (d13, d23) are at a shooting distance (D02) of the two dimensional image sequences (IM1i, IM2i) where said distance (D02) is smaller than the shooting distance (D0) coincident with the distance between transmittal direction (d3, d4) of the two-dimensional processed images (IM1E; IM2iE).

That is, as shown in FIG. 2C, the shooting distance of the detection tool (2) must be adapted, in this case enlarged, to be compatible with the distance between transmittal directions.

It is therefore clear that the optical splitter of the present invention is able to adapt to binocular tools, for example optical microscopes, having variable shooting distance (D0, D01, D02).

Cameras (TC1, TC2) are coupled to respective lenses (Ob1; Ob2) and in data link to their respective elaboration optics (Ot1, Ot2). Particularly, cameras are associated to respective lenses (Ob1, Ob2) or comprise said lenses. Cameras (TC1, TC2) are configured to receive processed two-dimensional image sequences (IM1iE, IM2iE) through respective lenses (Ob1, Ob2). Cameras are configured to receive processed two-dimensional image sequences (IM1iE, IM2iE) along their respective transmittal directions as shown in FIGS. 2A, 2B and 2C.

As can be seen in FIGS. 2A, 2B and 2C, advantageously, cameras (TC1, TC2) are placed in reciprocally parallel positions along their respective parallel transmittal directions (d3, d4). The achieved technical effect is a precise acquisition of images not subjected to spherical aberration. The resulting benefit is that final images that will be displayed on an appropriate visualization device will be precise and of a high quality.

Preferably, inside splitter (1) of the invention, cameras TC1, TC2 are sided in parallel between them, at a distance between the centre of the respective lenses (Ob1, Ob2), and therefore at a distance between d3 and d4, comprised between 20 cm and 30 cm, preferably equal to 26 cm. In one embodiment, the optical splitter (1) of the invention comprises deflection means (MD1, MD2) configured to deviate shooting directions along transmittal directions (d3, d4). Deflection means (MD1, MD2) are interposed between elaboration optics (Ot1, Ot2) and related cameras (TC1, TC2).

Preferably, deflection means (MD1, MD2) are equipped with two respective regulator prisms (PR11, PR12e PR13, PR14) configured to vary the distance between shooting directions (d1, d2, d11, d21, d13, d23) of two-dimensional image sequences (IM1i, IM2i) received from elaboration optics (Ot1, Ot2).

In one embodiment of the invention, deflection means (MD1, MD2) comprise a strip equipped with two regulator prisms (PR11, PR12 o PR13, PR 14), and configured to virtually vary the distance between optical axes (d1, d2) of respective lenses (Ob1, Ob2). Said distance variation is function of physical-functional features of the regulator prisms.

In other word, the strip allows to modify the distance between transmittal directions (d3, d4) inside the optical splitter (1), independently from the real distance (D0, D01, D02) calculated between shooting directions. A technical effect obtained in this way is, for example, a fitting of the optical splitter to whatever inter-pupillary distance different from the one initially foreseen for the splitter (1) of the invention. An achieved technical effect is the variation of the distance between optical axes functional to the application or use of the splitter. For example, for microscopes, the distance between optical axes compared to the one expected from the standard optical splitter (1) is smaller and can be adapted by the insertion of the described strip. Thus, with the same optical splitter (1) of the invention, the same cameras (TC1, TC2) and the same placement of the optics, different inter-pupillary distances can be simulated. Functionally, depending upon the requested application, the invention foresees the insertion of a matching strip to virtually vary the predefined distance between optical axes.

Elaboration optics (Ot1, Ot2) comprise related processing unit (S1, S2) configured for a further fitting in alignment and size of images (IM1i, IM2i) defining an optimal resolution of output images (IM1E, IM2E).

FIG. 7 shows an example of optical splitter (1) according to the invention exploded in its components. Particularly, this figure shows the splitter real construction, suitable for use, in which, for simplicity, lenses Ob1 and Ob2 are not shown. This figure illustrates how the splitter (1) comprises a housing (101) of a shape approximately of a parallelepiped equipped with a hole (102) on a first face of the lateral surface of the parallelepiped, and two holes (103, 104) on a second face of the lateral surface of the parallelepiped, on the opposite side of first one. In a medical application example, images coming from patient's eyes enter the two holes; the images come into contact with elaboration optics (Ot1, Ot2) particularly with two prisms (PR01, PR02).

Part of images move forward coming out of the rear hole, without being deviated from prisms, to reach a physician's observation ocular, in particular a shooting binocular. Part of images are deviated by the two prisms in a direction directed to cameras, thus parallel to lateral surfaces where holes dwell. Usefully, according to the invention, only images deviated toward cameras come into contact with deflection means (MD1, MD2).

This is necessary as cameras must be able to shoot in different modes, i.e. with different distances between shooting optical axes, depending on the distance between shooting optical axes (D01, D02) passing through the two holes of the splitter, i.e. depending on the distance between optical axes of detection tools.

FIG. 7 also shows a seal (105) upon which will be suited an adapter cork for a coupling with the detection tool (2) which detects image sequences (IM1i, IM2i). With reference to FIGS. 2A, 2B and 2C, the invention comprises a 3D image processing system (11) including tool (2) for the detection of the two-dimensional image sequences (IM1i, IM2i) along their respective shooting directions (d1, d2, d11, d21, d13, d23) and the described optical splitter (1) configured to receive two-dimensional image sequences (IM1i, IM2i). 3D image processing system (11) comprises a process unit (UC) configured to receive processed images (IM1iE, IM2iE) and synchronize images, generating in this way viewable images (I_3D).

Particularly, the process unit UC comprises: a receiving module (M1) configured to receive, from the optical splitter (1) processed images (IM1iE, IM2iE); a synchronization module (m2) configured to synchronize processed images (IM1iE, IM2iE), by which generating viewable images (I_3D).

The synchronization module (M2) is configured to synchronize images (IM1iE, IM2iE) by making a juxtaposition of images (IM1iE; IM2Ie) coming from cameras (TC1; TC2) and a consequent interlacing, thereby realizing viewable images (I_3D). Such a technique is described in the PCT application WO 2015/019368 of the same applicant.

Referring to FIG. 2, the invention comprises a 3D image visualization system (111) comprising a 3D image processing system (11) as previously described, and a visualization device (D3D) configured to receive and view viewable images (I_3D). Preferably, the visualization device (D3D) is configured to receive the viewable images through cabled or wireless network.

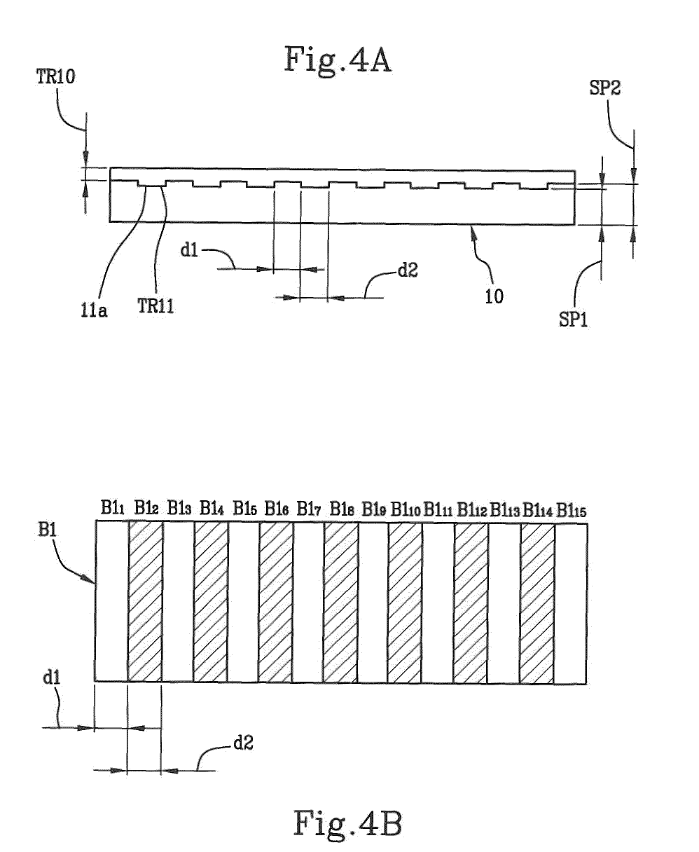

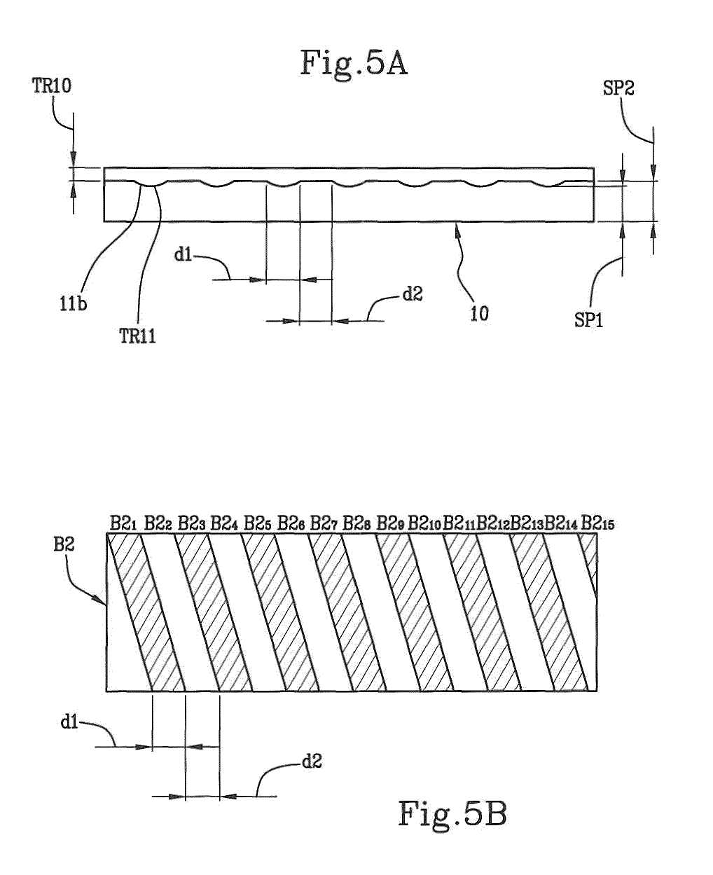

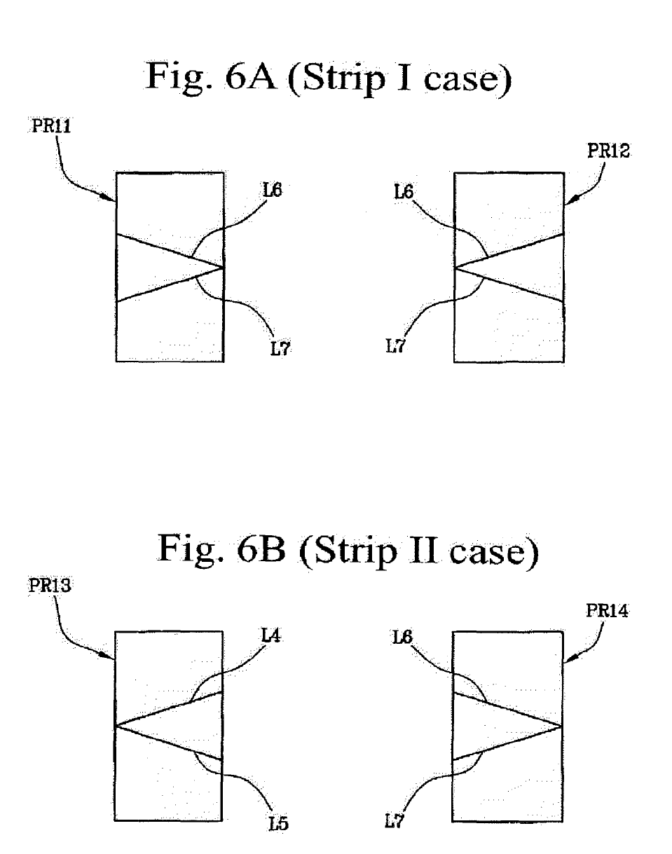

Referring to FIGS. 4A and 5A, the visualization device (D3D) comprises a transparent support (10) which realizes one between a mobile phone display, tablet or similar or one between PC monitors, TV or the like. In a first preferred embodiment of the invention, the transparent support (10) comprises a display of a cell phone, tablet or similar. In the second preferred embodiment of the invention, the transparent support (10) comprises a screen for TV, computer or the like.

The transparent support preferably consists of a glass sheet comprising a plurality of zones (11a, 11b) having reduced transmittance TR_11 when compared to the transmittance TR_10 of the transparent support (10). In a first embodiment of the invention (FIGS. 4a and 4b), the alternation of zones (11a) having reduced transmittance (TR_11) and of the transparent support (10) determines bands (B1i) that realize a parallax barrier (B1). Such bands (B1i) are shown in FIG. 4b as bands (B11-B115). Bands (B1i) realize a parallax barrier (B1) for displays of cell phones and the like, particularly of size from 1″ to 10″. In the second embodiment (FIGS. 5a, 5b), the alternation of zones (11b) having reduced transmittance (TR_11) and of the transparent support (10) determines bands (B2i) which realize a lenticular barrier (B2). Such bands are shown in FIG. 5b as bands (B21-B215).

Bands (B2i) realize a lenticular barrier (B2) for PC and TV screens, particularly of size from 10″ to 85″. Preferably, the transmittance of the zones (11) having reduced transmittance (TR_11) is about 50% ot the transmittance (TR_10) of the transparent support. Advantageously, according to the invention, the alternation of zones (11a, 11b) having reduced transmittance (TR_11) and of the transparent support (10) determines bands (B1i, B2i, with i=1 . . . n) that realize an autostereoscopic system (B1, B2). The resulting technical effect is the formation of an autostereoscopic barrier directly on the transparent support without the need of applying an additional layer to the support. Autostereoscopy allows the viewer not to wear special glasses since the physical structure allowing separation of images deriving from a source, is obtained in the transparent support (10). In a preferred embodiment, a laser incision on the transparent support (10) allows the formation of parallel bands (B1i, B2i) which realize the above described autostereoscopic barrier (B1, B2).

The autostereoscopic barrier allows viewing three-dimensional images without the need of using secondary optical devices such as stereoscope or glasses, since the support is provided with a system which provides to address to each eye the image intended to it; each eye sees a different set of pixels, thereby creating a sense of depth with the stereoscopic barrier similar to what is produced by appropriately specialized glass lenses.

The technical effect of 3D for cell phones tablets and the like is guaranteed by the support itself which, as previously described, is fitted with a system which provides to address to each eye the image intended to it for a 3D vision.

The set of techniques above described allow to realize a digital microscope comprising an optical microscope coupled with an optical separator as above described and a digital screen of size comprised between 10″ and 85″. In a preferred embodiment of the invention, the use screen is a glassless 3D screen which comprises a glass sheet comprising a plurality of zones (11a, 11b) having reduced transmittance TR_11 with respect to the transmittance (TR_10) of the transparent support, as above described.

1. Optical splitter (1), connectable to a tool (2) for the detection of sequences of two dimensional images (IM1i; IlvI2i) along respective directions of shooting (d1, d2, d11, d21, d13, d23), comprising:
a. elaboration optics (Ot1; Ot2) configured to:
receive said sequences of two-dimensional images (IM1i; IM2i);
process them to determine sequences of processed images ([M1iE; IM2iE);
transmit said sequences of processed images (IM1iE; IM2iE) along respective directions of transmission (d3; d4);
b. cameras (TC1, TC2), coupled to respective camera lenses (Ob1, Ob2) and in data connection with said respective elaboration optics (Ot1, Ot2), wherein said cameras (TC1, TC2) are configured to receive processed two-dimensional image sequences (IM1iE, IM2iE) through said lenses (Ob1, Ob2) along their respective transmittal directions (d3; d4), wherein said cameras (TC1, TC2) are oriented in mutual parallel position along their respective parallel transmittal directions (d3; d4).

2. Optical splitter (1) according to claim 1, wherein said elaboration optics (Ot1, Ot2) comprise an enlarging lens (LI) configured to resize input two-dimensional images (IM1i, IM2i) determining said enlarged processed two-dimensional images (IM1iE, IM2iE).

3. Optical splitter (I) according to claim 1, wherein the elaboration optics (Ot1, Ot2) comprise a manual focus.

4. Optical splitter (1) according to claim 1, wherein said elaboration optics (Ot1, Ot2) comprise respective prisms (PR01, PR02) equipped with a pair of respective lens (L2, L3), a positive one and a negative one, configured to resize input two-dimensional images (IM1i, IM2i), determining resized processed two-dimensional images (IM1iE, IM2iE).

5. Optical splitter (1) according to claim 1 comprising deflection means (MD1, MD2) interposed between said elaboration optics (Ot1, Ot2) and said respective cameras (TC1, TC2), equipped with two regulator prisms (PR11, PR12; PR13, PR14) configured to vary the distance between shooting directions (d1, d2, d11, d21, d13, d23) of two-dimensional image sequences (IM1i, IM2i) received from said elaboration optics (Ot1, Ot2).

6. Optical splitter (1) according to claim 1, wherein shooting directions (d1, d2) correspond respectively to said transmittal directions (d3, d4), being unchanged a distance (D0) present in shooting said sequences of two-dimensional images (IM1i, IM2i) and in transmission of said processed two-dimensional images (IM1iE, IM2iE).

7. Optical splitter (1) according to claim 1, wherein shooting directions (d11, d21) are at a shooting distance (D01) of said sequences of two-dimensional images (IM1i, IM2i) wherein said distance (D01) is greater than the distance (D0) between said transmittal directions (d3, d4).

8. Optical splitter (1) according to claim 1, wherein shooting directions (d13, d23) are at a distance (D02) of said sequences of two-dimensional images (TM1i, TM2i) wherein said distance (D02) is smaller than the distance (D0) between said transmittal directions (d3, d4).

9. 3D image processing system (11) comprising:
a. a tool (2) for the detection of two-dimensional image sequences (IM1i, IM2i) along the respective shooting directions (d1, d2, d11, d21, d13, d23);
b. an optical splitter (1) according to claim 1, configured to receive two-dimensional image sequences (IM1i, IM2i);
c. a control unit (UC) comprising:
a receiving modulus (M1) configured to receive processed images from said optical splitter (1);
a synchronization modulus (IM2) configured to synchronize said processed images (IM1iE, IM2iE), thereby generating viewable images (I_3D).

10. 3D image processing system (11) according to claim 9, wherein said synchronization modulus (IM2) is configured to synchronize said images (IM1iE, IM2iE) by making a juxtaposition of said images (IM1iE, IM2iE) coming from said cameras (TC1, TC2) and a consequent interlacing, thereby realizing viewable images (I_3D).

11. 3D visualization system (I11) comprising:
i. a 3D image processing system (II) according to claim 9;
ii. a 3D visualization device (D3D) configured to receive and display viewable images (I_3D).

12. D visualization system (111) according to claim 11, wherein said 3D visualization device (D3D) is configured to receive said viewable images (I_3D) through cabled network or wireless network.

13. 3D visualization system (111) according to claim 11, wherein said 3D visualization device (D3D) comprises a transparent support (10) which realizes one between a mobile phone display, tablet or similar or one between PC monitors, TV or similar.
